(19) United States
(12) Patent Application Publication
(10) Pub. No.: US 2022/0414721 A1
(43) Pub. Date: Dec. 29, 2022

(54) METHOD OF PREDICTING FARE AND PREDICTION DATA SYSTEM

(71) Applicant: GRABTAXI HOLDINGS PTE. LTD., Singapore (SG)

(72) Inventors: Xueheng QIU, Singapore (SG); Wentong LI, Singapore (SG); Chen WANG, Singapore (SG)

(21) Appl. No.: 17/619,654

(22) PCT Filed: Mar. 11, 2020
(86) PCT No.: PCT/SG2020/050124

§ 371 Date: Dec. 16, 2021

(51) Int. Cl. G06Q 30/02; G06Q 50/30; G06N 3/04; G06N 3/08

(52) U.S. Cl. CPC G06Q 30/0283; G06Q 50/30; G06Q 30/0201; G06N 3/0445; G06N 3/0454; G06N 3/08

(57) ABSTRACT

An aspect of the disclosure relates to a fare prediction data system and a method of predicting fare for transportation services, the method including: receiving, at a server, from a digital device, a request including a service time; calculating a predicted fare at the server; and sending the predicted fare from the server to the digital device. Calculating the predicted fare uses the service time, a long term surge prediction and a short term surge prediction as input in a fare estimator. The long term surge prediction may be calculated using a long term surge predictor (LTSP) and the short term surge prediction may be calculated using a short term surge predictor (STSP). The LTSP uses historical data, and the STSP uses the historical data and recent data which may be more recent than the historical data. Other aspects related to surge prediction systems, methods, and computer products including instructions for carrying out the any of the methods.

### TECHNICAL FIELD

Aspects of the disclosure relate to methods of predicting surge and/or fare, e.g., for transportation services. Other Aspects of the disclosure relate to computer products. Other aspects of the disclosure relate to surge and/or fare prediction data system.

### BACKGROUND

In ride hailing business, accurate estimation of how much it costs for passengers to travel to a specific location is crucial to serve the passengers and enhance their confidence in a service. A naive approach is to assume future fare and surge distributions are identical or very close to their historical distributions, and replicate old data at geohash to geohash pairs level to serve directly. However, one major drawback is that the naive approach is error-prone and inaccurate. Another pitfall is that storing geohash pair Key-Value feature at small time intervals requires massive storage space. Thus, it is desired to provide for an improved fare and/or surge estimation method which addresses the above issues.

### SUMMARY

An aspect of the disclosure relates to a method of predicting fare for transportation services. The method may include receiving, at a server, e.g., from a digital device, a request including a service time. The server may be a distributed server, for example including more than one physical server. The method may further include calculating a predicted fare at the server. The method may further include sending the predicted fare from the server to the digital device. Calculating the predicted fare may use the service time, a long term surge prediction and a short term surge prediction as input in a fare estimator.

The long term surge prediction may be calculated using a long term surge predictor (LTSP) and the short term surge prediction may be calculated using a short term surge predictor (STSP). The LTSP uses historical data. The short term surge predictor may use recent data and may further use one of: the historical data and the long term surge prediction. The recent data may be more recent than the historical data.

Another aspect of the disclosure relates to a method of predicting surge for transportation services. The method may include receiving, at a server, a request including a service time. The method may further include providing a predicted surge at the server based on a long term surge prediction calculated using a long term surge predictor; a short term surge prediction calculated using a short term surge predictor; or a combination thereof. The method may further include calculating the long term surge prediction. The method may further include calculating the short term surge prediction. The LTSP may be a trained long short-term memory (LSTM) neural network trained with historical data. The STSP may be a trained LSTM neural network trained with training data including the recent data, which is more recent than the historical data, wherein the training data optionally further includes the historical data and/or the long term surge prediction.

Another aspect of the disclosure relates to a fare prediction data system including a server. The server may be configured to receive a request including a service time, e.g., from a digital device. The server may include a LTSP for, e.g. configured to, calculating a long term surge prediction based on historical data. The server may include a STSP for, e.g. configured to, calculating a short term surge prediction based on recent data which may be more recent than the historical data. The server may include a fare estimator configured to calculate a predicted fare based on the service time and at least one of: the long term surge prediction, the short term surge prediction, the predicted surge, or of a combination thereof. The server may be configured to send the predicted fare to the digital device. The server may be a distributed server, for example including more than one physical server, or one or more computer systems.

Another aspect of the disclosure relates to a surge prediction data system for transportation services. The surge prediction data system may include a server configured to receive a request comprising a service time. The server may be further configured to provide a predicted surge. The predicted surge may be based on a long term surge prediction calculated using a LTSP; a short term surge prediction calculated using a STSP; or a combination thereof. The LTSP may include a first trained LSTM neural network trained with historical data. The STSP may include a second trained LSTM neural network trained with training data including the recent data, which is more recent than the historical data, wherein the training data optionally further includes the historical data and/or the long term surge prediction.

According to various embodiments, the recent data may have a higher temporal resolution than the historical data.

According to various embodiments, the recent data may include data from transactions completed within a pre-determined time period past from the current time.

According to various embodiments, data from transactions may be obtained from a real time transaction data stream.

According to various embodiments, the pre-determined time period has a duration chosen from 2 hours to 24 hours, preferably from 5 hours to 8 hours.

According to various embodiments, the long term surge prediction may be stored in a long term surge database which may be updated at a regular interval.

According to various embodiments, the regular interval may be equal or greater than one day.

According to various embodiments, the updating may include calculating the long term surge prediction for a plurality of regular intervals, e.g. 7 days.

According to various embodiments, the plurality of regular intervals may be grouped by a repeating cycle, e.g. a week or a month.

According to various embodiments, recent data may be processed in the form of a time series and added to the historical data.

According to various embodiments, a separation in time of data points of the time series may be of at least one minute, for example at least 10 minutes.

According to various embodiments, calculating the predicted fare may further use at least one of: a service time, a travelling speed, an estimated duration of travel, a routing distance, a pickup location, a drop-off location, vehicle type, weather, events, as input in the fare estimator.

According to various embodiments, the fare estimator may include a quantile regression neural network.

According to various embodiments, each of the predicted fare, the long term surge prediction, and the short term surge prediction may be provided, e.g., calculated, for a same geohash, for example, the geohash of a pick-up location.

According to various embodiments, the STSP may include a trained long short-term memory neural network.

According to various embodiments, the LTSP may include a trained long short-term memory neural network.

According to various embodiments, the historical data may be stored in a first memory and the recent data may be stored in a second memory, optionally, wherein the first memory and the second memory are of a different type.

Another aspect of the disclosure relates to a computer product including instructions for carrying out the method of predicting fare and/or the method of predicting surge of predicting fare in accordance with various embodiments.

Another aspect of the disclosure relates to a fare prediction data system for predicting fares according to the method of predicting fare in accordance with various embodiments.

Another aspect of the disclosure relates to a surge prediction data system for predicting surges according to the method of predicting fare in accordance with various embodiments.

### BRIEF DESCRIPTION OF THE DRAWINGS

The invention will be better understood with reference to the detailed description when considered in conjunction with the non-limiting examples and the accompanying drawings, in which:

FIG. 1A shows a diagram of a fare prediction data system 100A, in accordance with some embodiments;

FIG. 1B shows a diagram of fare prediction data system 100B, in accordance with some embodiments;

FIG. 2 shows a flowchart of a method 1000, in accordance with various embodiments;

FIG. 3A shows a flowchart of a method 2000, for illustrating how the long term surge database may be updated;

FIG. 3B shows a schematic of long term surge data in the long term surge database.

FIG. 4 shows a flowchart of a method 3000, for illustrating how the short term surge database may be updated;

FIG. 5 shows a flowchart of a method 4000 which is a variant of the method 3000 of FIG. 4; and

FIG. 6 shows a flowchart of a method 5000 which is a variant of the method 4000 of FIG. 5;

FIG. 7A shows a table with an example of raw service request data.

FIG. 7B shows a table with surge data, as an example of recent data.

FIG. 8 shows the architecture of an exemplary computer system 6000 which may be used to implement any system in accordance with various embodiments, or any method in accordance with various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a system are analogously valid for a method, and vice-versa.

Embodiments described in the context of a method of predicting fare are analogously valid for a method of predicting surge, and vice-versa. Similarly, embodiments described in the context of a fare predicting data system are analogously valid for a surge predicting data system, and vice-versa.

Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

As used herein and in the context of various embodiments, the articles “a”, “an” and “the” as used with regard to a feature or element include a reference to one or more of the features or elements.

As used herein and in the context of various embodiments, the term “and/or” includes any and all combinations of one or more of the associated listed items.

As used herein and in the context of various embodiments, the expression “service time” may mean a pick-up time or a drop off time, e.g. it may mean the service time at which the passenger wishes to be picked up at the pick-up location or the service time at which the passenger wishes to be dropped-off up at the drop-off location.

As used herein and in the context of various embodiments, “transportation services” may include ride hailing services, vehicle rental services, food delivery services, package delivery services, and other services requiring transportation.

According to various embodiments, a fare and/or a surge may be predicted for a geohash, thus a request for a fare or for a surge may include the geohash. The geohash may indicate the pick-up location for the service.

As used herein and in the context of various embodiments, the expression “predicted surge” may mean a surge calculated based on a long term surge prediction calculated using a long term surge predictor; a short term surge prediction calculated using a short term surge predictor; or a combination thereof. For example the predicted surge may be selected from one of the long term surge prediction or the short term surge prediction.

As used herein and in the context of various embodiments, the “second” and “first” as used in connection with an LSTM, is used for distinguishing the LSTMs without limitation. For example, a “second LSTM” may be provided without a “first LSTM” being required.

It was found that both of long and short term surge and/or fare distributions can be used to obtain a more accurate fare estimate.

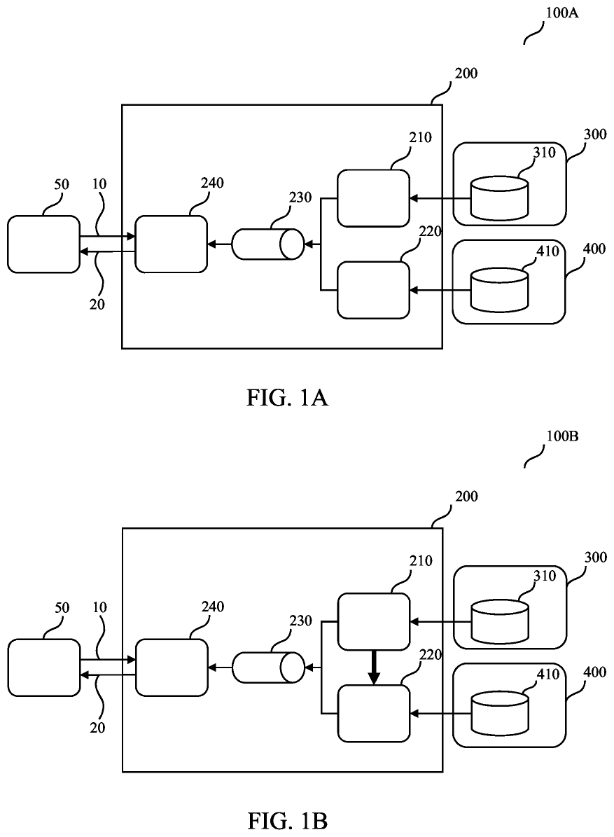

FIG. 1A shows a diagram of a fare prediction data system 100A including a back end system such as a server 200, a first memory 300, and a second memory 400.

According to various embodiments, the first memory 400 may store recent data 410. The first and the second memories may be of a different type. For example, the first memory 300 may include or be, e.g., non-volatile memory, the second memory 400 may include or be, e.g., a volatile memory. Data, such as historical data 310 or recent data 410 may be transmitted from the respective memory to the server 200 via a communication interface. For example, data may be fetched via a JavaScript Object Notation (JSON) request over the communication interface.

According to various embodiments, recent data is more recent than the historical data 310. According to various embodiments, recent data 410 may include data from transactions completed within a pre-determined time period Δt₁ past from current time. Data from transactions may be obtained from a real time transaction data stream. The pre-determined time period Δt₁ may have a duration chosen from 2 hours to 24 hours, preferably from 5 hours to 8 hours. Thus, recent data 410 may be or may include real time data. For example, when the pre-determined time period Δt₁ is chosen as 5 hours the recent data includes data from transactions completed within the last 5 hours.

In some embodiments, the real-time data may be produced by online pipelines in memory, and may then be output and stored in a message queue system, e.g., which has its own persistent storing mechanism.

According to various embodiments, recent data may be processed in the form of a time series and added to the historical data. The separation in time of data points of the time series may be of at least one minute, for example at least 10 minutes. In some embodiments, the historical data may be produced by offline pipelines and may be stored in persistent non-volatile storage.

According to various embodiments, the recent data may have a higher temporal resolution than the historical data. The short term surge prediction may be more accurate due to a higher temporal resolution of the recent data, and the training of the LTSP 210 and calculation of the long term surge prediction may be faster and more energy efficient due to the lower temporal resolution. For example, the higher temporal resolution may be selected from 1 minute to 5 minutes. For example, the lower temporal resolution may be selected from 5 minutes to 60 minutes.

According to various embodiments, the server 200 may be configured to receive a request 10 comprising a service time from a digital device 50. The server 200 may include a LTSP 210 and may further include a STSP 220. The LTSP 210 may be configured to calculate a long term surge prediction based on the historical data 310. The STSP 220 may be configured to calculate a short term surge prediction based on recent data 410. The request 10 may include a geohash.

According to some embodiments, when the LTSP 210 receives the request from the fare estimator 240, the LTSP 210 sends the calculated long term surge prediction to the fare estimator 240. When the STSP 220 receives the request from the fare estimator 240, the STSP 220 sends the calculated long term surge prediction to the fare estimator 240. According to some embodiments, the LTSP 210 may receive the request from the fare estimator 240 via the dispatcher 230. According to some embodiments, the STSP 220 may receive the request from the fare estimator 240 via the dispatcher 230. Each of the calculated long term surge prediction, and the calculated long term surge prediction may be for the geohash, e.g., as received with the request 10.

According to various embodiments, the server 200 may further include a fare estimator 240, configured to calculate a predicted fare 20 based on a service time and one or both of: the long term surge prediction as determined by the LTSP 210, and the short term surge prediction as determined by the STSP 220. The fare estimator may also base the calculation of the predicted fare 20 on other data such as one or more of: a service time, a travelling speed, an estimated duration of travel, a routing distance, a pickup location, a drop-off location, vehicle type, weather, events. When receiving the request 10, the fare estimator 240 may send a request for surge prediction based on the service time to one or both of: the LTSP 210, the STSP 220. In some embodiments, the fare estimator 240 may send a request for surge prediction to the dispatcher 230. The request may include the service time. The dispatcher 230 may decide, based on the service time, whether to request for surge prediction to one or both of: the LTSP 210, the STSP 220. In some embodiments, the dispatcher 230 may receive the long term surge prediction as determined by the LTSP 210 and/or the short term surge prediction as determined by the STSP 220, upon request, and send it to the fare estimator 240.

A surge prediction data system, according to some embodiments may be identical to the one shown in FIG. 1A or FIG. 1B without the fare estimator 240. If required, for example for transportation service fare estimation, a fare estimator 240 may be external (i.e., not included) to the server 200 and to the surge prediction data system.

In an example, when the request 10 has a service time at a time t_{S1} (in the future), which is before the current time t_{now} added by the pre-determined time period Δt₁ (for example, t_{S1}<t_{now}+Δt₁), the fare estimator 240 may request the short term surge prediction from the STSP 220, and may further request the long term surge prediction from the LTSP 210. After receiving the calculated short term surge prediction and the long term surge prediction, the fare estimator 240 may calculate the predicted fare based on the short term surge prediction and the long term surge prediction. Using both the short term surge prediction and the long term surge prediction may increase fare estimation accuracy. Alternatively, in another example, when the request 10 has a service time at a time t_{S2} (in the future), which is after the current time t_{now} added by the pre-determined time period Δt₁ (for example, t_{S2}>t_{now}+Δt₁), the fare estimator 240 requests the long term surge prediction from the LTSP 210. After receiving the determined long term surge prediction, the fare estimator 240 may calculate the predicted fare based on the long term surge prediction. Using the long term surge prediction and not using the short term surge prediction may increase efficiency, e.g., by increasing speed and lowering power consumption.

In another example, when the request 10 has a service time at a time t_{S3} which is before the current time t_{now} added by the pre-determined time period Δt₂ (for example, tₛ₃<t_{now}+Δt₂), the fare estimator 240 may request the short term surge prediction from the STSP 220, and may further request the long term surge prediction from the LTSP 210. After receiving the determined short term surge prediction and the long term surge prediction, the fare estimator 240 may calculate the predicted fare based on the short term surge prediction and the long term surge prediction. Using both the short term surge prediction and the long term surge prediction may increase fare estimation accuracy. Alternatively, in another example, when the request 10 has a service time at a time tₛ₄ which is after the current time t_{now} added by the pre-determined time period Δt₂ (for example, tₛ₄>t_{now}+Δt₂), the fare estimator 240 may request the short term surge prediction from the STSP 220, and may calculate the predicted fare based on the short term surge prediction and not based on the long term surge prediction. Using the short term surge prediction and not using the long term surge prediction may increase efficiency, e.g., by increasing speed and decreasing cpu and memory utilization.

FIG. 1B shows a diagram of a fare prediction data system 100B, which may be identical to the fare prediction data system 100A, except that the STSP 220 is configured to calculate a short term surge prediction based on the recent data 410 and based on the long term surge prediction as calculated by the LTSP 210. The STSP 220 may be configured to receive the long term surge prediction from the LTSP 210 as indicated in FIG. 1B by the arrow pointing from the LTSP 210 to the STSP 220. In some embodiments, when the request 10 has a service time at a time tₛ₃ which is before the current time t_{now} added by the pre-determined time period Δt₂ (for example, tₛ₃<t_{now}+Δt₂), the fare estimator 240 may request the short term surge prediction from the STSP 220. In embodiments wherein the STSP 220 calculates the short term surge prediction based, not only on the recent data 410, but also on the based on the long term surge prediction, the long term surge prediction is already taken into consideration and the fare estimator 240 does not need to request the long term surge prediction from the LTSP 210 for calculating the fare. After receiving the determined short term surge prediction, the fare estimator 240 may calculate the predicted fare 20 based on the short term surge prediction.

According to various embodiments, each of the pre-determined time period Δt₁ and the pre-determined time period Δt₂ may be independently chosen from 2 hours to 24 hours, preferably from 5 hours to 8 hours.

According to various embodiments, the LTSP 210 may include a first long short-term memory (LSTM) neural network for long term surge prediction based on historical data 310, for example, the first LSTM neural network may be trained with training data to provide long term surge prediction based on historical data. The trained first LSTM neural network may be fed continuously with historical data, for example, at first pre-defined update intervals. An update interval of the first pre-defined update intervals may be selected from 1 minute to 200 minutes, for example the update interval may be 15 minutes. The first pre-defined update intervals may be regular (i.e. each having the same time interval). The prediction may be carried out for a period of time ahead, for example selected from 1 week to 12 months, such as 1 week. Thus, for every update interval, the prediction (e.g., for a same geohash) may be carried out for the time ahead, providing a rolling prediction. The time ahead may be segmented into slots, for example, each time slot of the slots being selected from 2 hours minutes to 12 hours, or from 5 minutes to 20 minutes, for example, 15 minutes. Each time slot of the slots may be of identical interval. Alternatively or in addition to the prediction being carried out for a period of time ahead, the prediction may be provided on demand. For example, the LSTM may receive a service time as input and calculate the long time surge prediction for the service time. The on demand prediction may save storage space. On the other hand, the prediction being carried out for a period of time ahead may be relatively faster, especially when demand is high.

According to various embodiments, the LTSP 210 may be trained periodically. The training may be a retraining, for example when the LTSP 210 is already trained at least once, and additional historical data is used for further training (named herein as retraining), thereby updating the LTSP 210. The retraining may occur after each update interval, including historical data, for example including historical data of a preceding epoch for which historical data is available. Retraining after each updating interval may increase the accuracy of the prediction, however may be more demanding on computational resources. Alternatively or in addition, the retraining may occur after a longer training interval, which may be longer than the update interval, such as 12 hours or 24 hours. Such a longer training interval may be sufficient for the LTSP 210 and may be less demanding on computational resources. In some embodiments, the training may start from a randomly initialized LSTM of the LTSP 210, for example, when a determined lower loss threshold is not achieved with retraining. The skilled person in the art will understand that references herein to “training the LTSP”, and variations thereof, also refer to the training of the components of the LTSP, including the LSTM of the LTSP.

According to various embodiments, the STSP 220 may include a second LSTM neural network for short term surge prediction forecasting based on historical data 310, for example, the second LSTM neural network may be trained with training data to provide short term surge prediction forecasting based on recent data 410. The trained second LSTM neural network may be fed continuously with recent data, for example, at each of second pre-defined update intervals. An update interval of the second pre-defined update intervals may be selected from 1 minute to 200 minutes, for example the update interval may be 60 minutes. The second pre-defined update intervals may be regular. The prediction may be carried out for a period of time ahead, for example selected from 2 hours to 24 hours, for example from 5 hours to 8 hours, such as 6 hours. The period of time ahead may also be selected to be the pre-determined time period Δt₁ or the pre-determined time period Δt₂. Thus, for every update interval, the prediction (e.g., for a same geohash) may be carried out for the time ahead, providing a rolling prediction. The time ahead may be segmented into slots, for example, each time slot of the slots being selected from 2 minutes to 12 hours, or from 5 minutes to 20 minutes, for example, 15 minutes. Each time slot of the slots may be of identical interval. Alternatively or in addition to the prediction being carried out for a period of time ahead, the prediction may be provided on demand. For example, the LSTM may receive a service time as input and calculate the long time surge prediction for the service time. The on demand prediction may save storage space. On the other hand, the prediction being carried out for a period of time ahead may be relatively faster, especially when demand is high.

According to various embodiments, the STSP 220 may be trained periodically. The training may be a retraining, for example when the STSP 220 is already trained at least once, and training data is used for further training (named herein as retraining), thereby updating the STSP 220. The retraining may occur after each update interval of the forecast, including training data, for example including training data of a preceding epoch for which training data is available. Training data may include recent data 410. Optionally, training data may further include the long term surge prediction. Retraining after each updating interval may increase the accuracy of the prediction, however may be more demanding on computational resources. Alternatively or in addition, the retraining may occur after a longer training interval, which may be longer than the update interval, such as 12 hours or 24 hours. Such a longer training interval may be sufficient for the STSP 220 and may be less demanding on computational resources. In some embodiments, the training may start from a randomly initialized LSTM of the STSP 220, for example, when a determined lower loss threshold is not achieved with retraining. The skilled person in the art will understand that references herein to “training the STSP”, and variations thereof, also refer to the training of the components of the STSP, including the LSTM of the STSP.

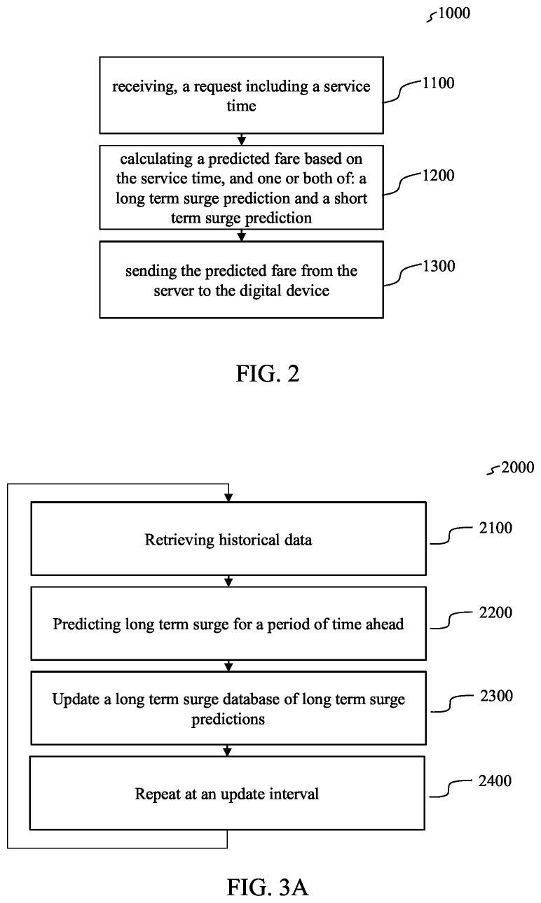

FIG. 2 shows a flowchart of a method 1000, in accordance with various embodiments. In a step 1100, a request including a service time is received, e.g., by the server 200. Such request may have been sent by a users' (e.g., a passenger) digital device 50. The method may further include calculating 1200 a predicted fare 20 at the server. The fare 20 may be calculated based on the service time, and one or both of: the long term surge prediction and the short term surge prediction. In some embodiments, calculating the predicted fare 20 uses the service time, the long surge prediction, and the short surge prediction as input in the fare estimator 240. The long surge prediction may be calculated using the LTSP 210 and the short surge prediction may be calculated using the STSP 220. The method may further include a step 1300 of sending the predicted fare 20 from the server 200 to the digital device 50. In one example, when a request is made at the users' app (e.g., on a digital device) to retrieve a trip fare for a particular pick up location (e.g. having a corresponding geohash) to reach a specific destination at a service time, the request is sent to the fare estimator which calculates the predicted fare and sends the predicted fare to the users' app.

According to various embodiments, each of the predicted fare 20, the long term surge prediction, and the short term surge prediction, as needed, may be calculated for a same geohash.

According to various embodiments, calculating the predicted fare may further use as input in the fare estimator one or more of: a service time, a travelling speed (e.g., an estimated average travelling speed), an estimated duration of travel, a routing distance, a pickup location, a drop-off location, vehicle type, weather, events. Thus, in addition to the long term surge prediction and/or the short term surge prediction, the predicted fare may be calculated further based on one or more of: a service time, a travelling speed (e.g., an estimated average travelling speed), an estimated duration of travel, a routing distance, a pickup location, a drop-off location, vehicle type, weather, events.

According to various embodiments, the fare estimator 240 may include a quantile regression neural network. The quantile regression neural network may be trained. A quantile regression neural network may be a feedforward neural network with quantile regression loss. A quantile is the value below which a fraction of observations in a group falls. For example, a prediction for quantile 0.9 should over-predict 90% of the times. Regression based on quantile loss provides sensible prediction intervals even for variables with non-constant variance or non-normal distribution, which is quite suitable to predict surge/fare ranges.

According to various embodiments, each of the STSP 220 and/or the LTSP 210 may provide the surge as a prediction including multiple quantile levels, e.g., 40%, 50%, 60%, 70%, 80%, 90% and 95%, which may then be used for fare prediction. Therefore, when the other information required to determine the fare, e.g., the trip length, is provided, a fare prediction including multiple quantile levels may be calculated by the fare estimator. Such a fare prediction including multiple quantile levels may be provided to a user for user's decision to accept/not accept the advance booking, for example, as numbers displayed on the digital device 50. Alternatively or in addition, an exact fare may be provided to the user, for example calculated based on a pre-defined quantile (e.g., at 80%), a mode of the distribution, a median of the distribution, or a combination of the foregoing.

According to various embodiments, the LTSP 210 may use historical data 310. The STSP 220 may use the long surge prediction and/or recent data 410 which may be more recent than the historical data 310. In some embodiments, the STSP 220 may use the long term surge prediction and the recent data 410 which may be more recent than the historical data 310.

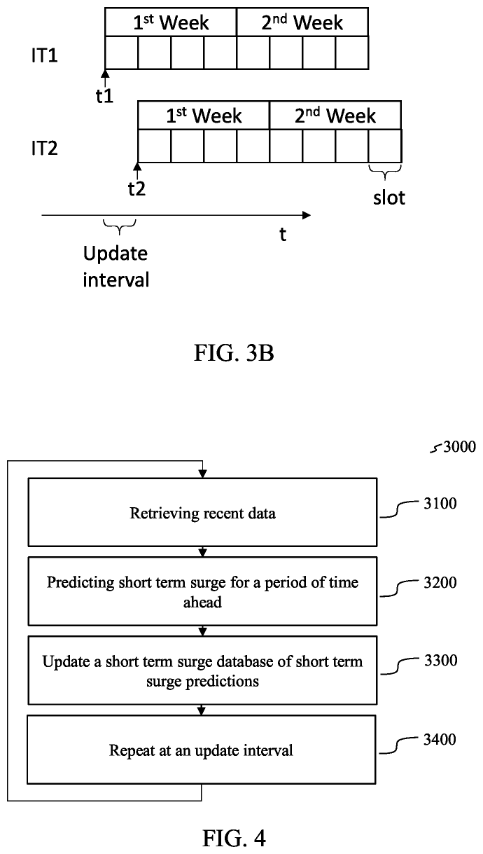

FIG. 3A shows a flowchart of a method 2000, for illustrating how the long term surge database may be updated, in accordance with various embodiments. FIG. 3B shows a schematic of long term surge data in the long term surge database. FIG. 3B uses the long term surge as an example, but also applies as example for the short term surge data in the short term surge database, with the respectively modified slots, update interval, and repeating cycles for the short term surge prediction. In a step 2100, using a first iteration (IT1) at a current time t₁, historical data 310 may be retrieved, e.g., by the server 200, from the first memory 300. In a step 2200, the long term surge prediction may be calculated for the period of time ahead for the LTSP, e.g., for the 2 weeks ahead, as shown by “1^{st} Week” and “2^{nd} Week”. In a step 2300, the long term surge database may be updated with the long term surge predictions. These steps may be repeated (2400) continuously, for example at an update interval (“Update interval”) of the first pre-defined update intervals. In the example of FIG. 3B, a second iteration IT2 starts a current time t2, having the update interval of t2−t1. The update interval may be different to the slot duration, or may be equal as shown in FIG. 3B for illustration purposes. The period of time ahead may be a repeating cycle, for example one or more weeks, one or more month, or both. The repeating cycle may include, or be segmented, into the slots, wherein the slots may be regular (i.e. each having the same time interval, e.g., “slot”).

FIG. 4 shows a flowchart of a method 3000, for illustrating how the short term surge database may be updated, in accordance with various embodiments. In a step 3100, recent data 410 may be retrieved, e.g., by the server 200, from the second memory 400. In a step 3200, the short term surge prediction may be calculated for the period of time ahead for the STSP. In a step 3300, the short term surge database may be updated with the short term surge predictions. These steps may be repeated (3400) continuously, for example after an update interval of the second pre-defined update intervals. The update interval may be different or equal to the slot duration.

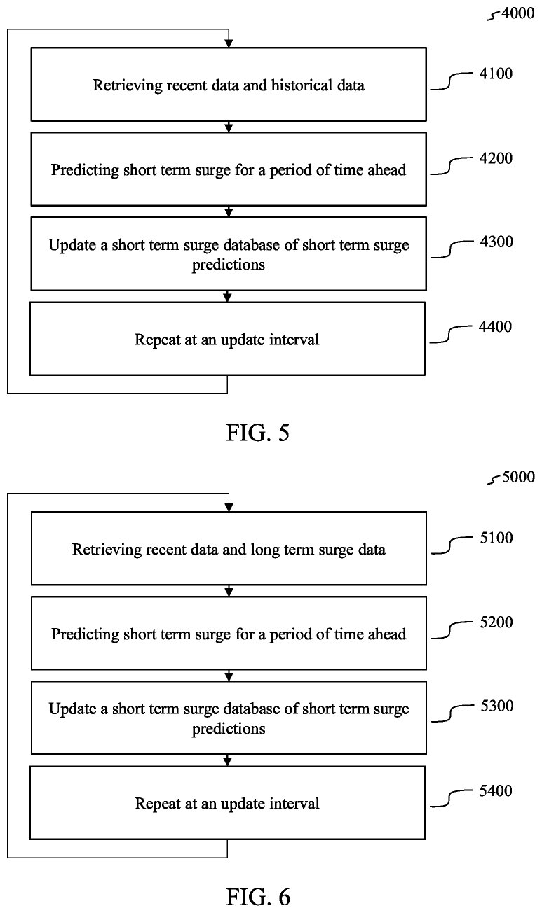

FIG. 5 shows a variant of the method 3000 of FIG. 4, in accordance with various embodiments. Instead of using the recent data and not using the historical data, in the method 4000, both of the recent data and the historical data are used. In more details, FIG. 5 shows a flowchart of a method 4000, for illustrating how the short term surge database may be updated. In a step 4100, recent data 410 may be retrieved, e.g., by the server 200, from the second memory 400. Furthermore, historical data 310 may be retrieved, e.g., by the server 200, from the first memory 300. In a step 4200, the short term surge prediction may be calculated for the period of time ahead, based on the recent data 410 and the historical data 310. In a step 4300, the short term surge database may be updated with the short term surge predictions. These steps may be repeated (4400) continuously, for example after an update interval.

FIG. 6 shows a variant of the method 4000 of FIG. 5, in accordance with various embodiments. Instead of using the recent data and the historical data, in the method 5000, both of the recent data and the long term surge data are used. The long term surge data includes long term surge calculated by the LTSP. In more details, FIG. 6 shows a flowchart of a method 5000, for illustrating how the short term surge database may be updated. In a step 5100, recent data 510 may be retrieved, e.g., by the server 200, from the second memory 500. Furthermore, long term surge data may be retrieved, e.g., by the server 200. In a step 5200, the short term surge prediction may be calculated for the period of time ahead, based on the recent data 510 and the long term surge data. In a step 5300, the short term surge database may be updated with the short term surge predictions. These steps may be repeated (5400) continuously, for example after an update interval.

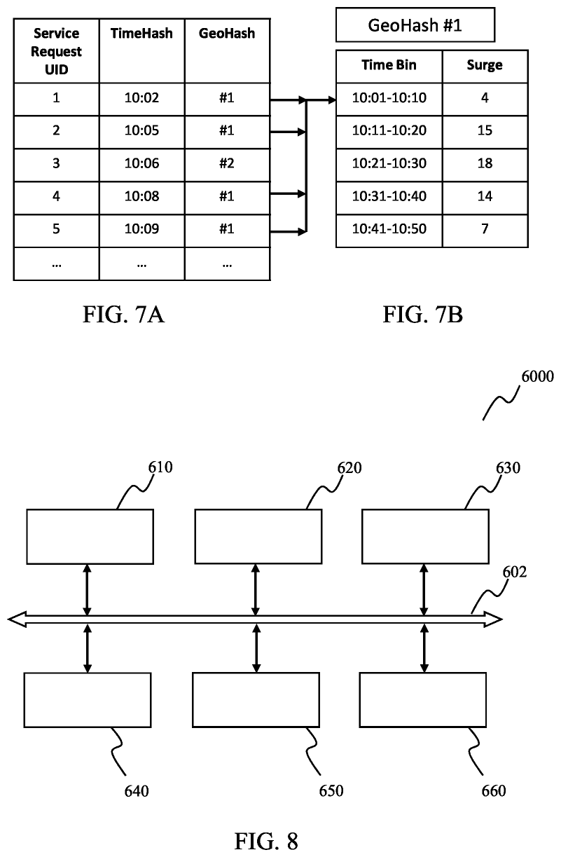

FIGS. 7A and 7B show how service request data may be prepared to be used as recent data and/or historical data. FIG. 7A shows a table with an example of raw service request data. An optional “Service Request UID” column provides a unique identifier (UID) for each service request. FIG. 7A shows service requests 1 to 5, for illustration purposes. A service time information may be provided, for example in the form of a time hash (see column “TimeHash”) or time stamp. It can be seen in FIG. 7A that service requests 1 to 5 have service times ranging from 10:02 to 10:09, for illustration purposes. Furthermore, the table in FIG. 7A shows a column “GeoHash” indicating a geohash as either #1 or #2 for illustration purposes, the geohash may be a coordinate, a vector, or another representation. The geohash may indicate the pick-up location for the service.

FIG. 7B shows a table with surge data, as an example of recent data for a single geohash (e.g. #1), the surge data is represented as time bins, e.g., of 10 minutes, such as from 10:01 to 10:10, from 10:11 to 10:20, and so on, however the disclosure is not limited thereto. For each time bin a surge is calculated, for example as the sum of service requests having a time has within the time bin. Using the service data from FIG. 7A, it can be seen that within the time bin 10:01 to 10:10 the surge is 4 (as is indicated by the arrows). The surge data may be used as recent data and/or historical data.

FIG. 8 shows the architecture of an exemplary computer system 6000, which may be used in a server 200 in accordance with various embodiments. The computer system 6000 includes a bus 610 through which one or more of the devices may communicate with each other. In the example of FIG. 8, the following devices are shown connected to the bus 600: a CPU 601; a main memory 602, for example a RAM; a storage device 603, for example a hard disk drive, a solid state drive, a flash drive; a communication device 604, for example for wired or wireless communication, e.g. WiFi, USB, Bluetooth; a display interface 605, and other user interfaces 606, for example for user input; however the disclosure is not limited thereto, and more or less devices may be included in the computer and the computer and/or bus may have other architectures than the one illustrated. A computer product in accordance with various embodiments may be a computer system 6000 configured to carrying out the method in accordance with various embodiments.

The present disclosure describes methods and systems for fare and/or surge predictions that are able to capture substantial time series factors that normally have both seasonality and long term trend. The disclosed methods are able to capture both short and long trends, serve online with small storage cost, while at the same time result in significantly accurate fare and/or surge estimation. Systems according to various embodiments use hybrid fare and/or surge fare estimation (e.g. ride fare) by leveraging deep learning technologies.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of predicting fare for transportation services, comprising:
receiving, at a server, a request comprising a service time; and
calculating a predicted fare at the server;
wherein calculating the predicted fare uses the service time, a long term surge prediction and a short term surge prediction as input in a fare estimator,
wherein the long term surge prediction is calculated using a long term surge predictor (LTSP) and the short term surge prediction is calculated using a short term surge predictor (STSP),
wherein the LTSP uses historical data, and
the STSP uses the recent data which is more recent than the historical data and at least one of: the historical data and the long term surge prediction,
wherein the LTSP is a first trained LSTM neural network, and
the STSP is a second trained LSTM neural network.

2. The method of claim 1, further comprising sending the predicted fare from the server to the digital device.

3. The method of claim 1, wherein the recent data has a higher temporal resolution than the historical data.

4. The method of claim 1, wherein the recent data comprises data from transactions completed within a pre-determined time period past from current time, wherein data from transactions is obtained from a real time transaction data stream.

5. The method of claim 4, wherein the pre-determined time period has a duration chosen from 2 hours to 24 hours, preferably from 5 hours to 8 hours.

6. The method of claim 1, wherein the long term surge prediction is stored in a long term surge database which is updated at a regular interval.

7. The method of claim 6, wherein the regular interval is equal or greater than one day.

8. The method of claim 6, wherein the updating includes calculating the long term surge prediction for a plurality of regular intervals.

9. The method of claim 8, wherein the plurality of regular intervals are grouped by a repeating cycle, e.g. a week or a month.

10. The method of claim 1, wherein recent data is processed in the form of a time series and added to the historical data.

11. The method of claim 10, wherein a separation in time of data points of the time series is of at least one minute, for example at least 10 minutes.

12. The method of claim 1, wherein calculating the predicted fare further uses at least one of: a service time, a travelling speed, an estimated duration of travel, a routing distance, a pickup location, a drop-off location, vehicle type, weather, events as input in the fare estimator.

13. The method of claim 1, wherein the fare estimator comprises a quantile regression neural network.

14. The method of claim 1, wherein each of the predicted fare, the long term surge prediction, and the short term surge prediction are calculated for a same geohash.

15. (canceled)

16. A fare prediction data system including a server,
wherein the server is configured to receive a request comprising a service time from a digital device,
wherein the server (200) comprises:
a long term surge predictor (LTSP) for calculating a long term surge prediction based historical data;
a short term surge predictor (STSP) for calculating a short term surge prediction based on recent data which is more recent than the historical data; and
a fare estimator configured to calculate a predicted fare based on the service time and one or both of: the long term surge prediction and the short term surge prediction,
wherein the server is configured to send the predicted fare the digital device,
wherein the LTSP is a first trained LSTM neural network, and
the STSP is a second trained LSTM neural network.

17. The fare prediction data system of claim 16, wherein the STSP is configured to calculate the short term surge prediction based on the recent data and at least one of: the historical data and the long term surge prediction.

18. The fare prediction data system of claim 16, wherein the historical data is stored in a first memory and the recent data are stored in a second memory optionally, wherein the first memory (300) and the second memory are of a different type.

19. (canceled)

20. A method of predicting surge for transportation services, comprising:
receiving, at a server, a request comprising a service time; and
providing a predicted surge at the server based on a long term surge prediction calculated using a long term surge predictor (LTSP); and a short term surge prediction calculated using a short term surge predictor (STSP),
wherein the LTSP is a trained LSTM neural network trained with historical data, and
the STSP is a trained LSTM neural network trained with training data including the recent data, which is more recent than the historical data, wherein the training data optionally further includes the historical data and/or the long term surge prediction.

21. (canceled)
